(19) United States
(12) Patent Application Publication
(10) Pub. No.: US 2023/0348731 A1
(43) Pub. Date: Nov. 2, 2023

(54) UREA URETHANE COMPOUNDS

(71) Applicant: BASF SE, Ludwigshafen am Rhein (DE)

(72) Inventors: Huiguang KOU, Ludwigshafen am Rhein (DE); Matthias MAIER, Ludwigshafen am Rhein (DE); Isabell HERZOG, Ludwigshafen am Rhein (DE); Clemens AUSCHRA, Ludwigshafen am Rhein (DE)

(21) Appl. No.: 18/022,529

(22) PCT Filed: Aug. 19, 2021
(86) PCT No.: PCT/EP2021/073009

§ 371 Date: Feb. 22, 2023

(30) Foreign Application Priority Data
Aug. 24, 2020 (EP) 20192436.2

(51) Int. Cl. C09D 5/04; C08G 18/08; C08G 18/22; C08G 18/28; C08G 18/32

(52) U.S. Cl. CPC C09D 5/04; C08G 18/0852; C08G 18/225; C08G 18/283; C08G 18/3234

(57) ABSTRACT

The presently claimed invention relates to urea urethane compounds obtainable by reacting toluene diisocyanate with a mixture of monohydroxy alcohols followed by reaction with a diamine. The presently claimed invention provides a process for preparing the urea urethane compounds, liquid compositions comprising the urea urethane compounds and the use of the urea urethane compounds as a thickening and thixotropic agent for water based and solvent based paint and coating formulations, lacquer, varnish, paper coating, wood coating, adhesive, ink, cosmetic formulation, detergent formulation, textile and drilling muds plaster formulations, PVC plastisol and cement formulations.

### FIELD OF THE INVENTION

The presently claimed invention relates to urea urethane compound obtainable by reacting toluenediisocyanate with a mixture of monohydroxy alcohols, and a process for preparation thereof. Further the presently claimed invention relates to a use of liquid compositions comprising the urea urethane compound as a thixotropic agent for paint and coating formulations, adhesive, paint lacquer, PVC plastisol, ink and cement formulations.

### BACKGROUND OF THE INVENTION

Urea urethane compounds are useful as thixotropic agents or rheology modifier additives in liquid compositions such as paints and coating formulations. The urea urethane compounds are capable of forming reversible hydrogen bonds. Urea urethane compounds form hydrogen bonds with the components of a liquid composition and form a gel. When shear force is applied in the form of mixing, shaking etc., the hydrogen bonds break and the liquid composition becomes flowable. Upon removal of the shear force, the hydrogen bonds are restored, and the liquid composition again forms a gel.

Urea urethane compounds are prepared from diisocyanates. The reaction of an isocyanate with an alcohol yields a urethane and the reaction of an isocyanate with an amine yields a urea. The properties of a urea urethane compound depend on the reactants and their ratios. There is a constant need to obtain urea urethane compounds having desired properties such as thixotropic behavior. Further, it is desired that the urea urethane compounds are capable of acting as thixotropic agents in aqueous coating compositions.

Different approaches have been suggested in the prior art to obtain the urea urethane polymers.

U.S. Pat. Nos. 4,383,068 and 3,893,956 describe processes in which polyisocyanate adducts of mono-alcohols with diisocyanates and, where appropriate, diisocyanates are reacted with primary and/or secondary polyamines in the mandatory presence of binders to form urea adducts. These urea urethane polymers are prepared in a binder or carrier medium. These binders then have a rheology control property. The rheology control agents cannot be prepared on theft own, without these carrier media, and consequently are of only limited usefulness.

U.S. Pat. No. 4,522,986 describes urethane-urea compounds which are prepared by reacting an NCO-terminated urethane prepolymer with an ethanol amine so as to form hydroxyurea-terminated rheology control agents. These NCO-terminated urethane prepolymers are obtained by reacting a polyether polyol with a stoichiometric excess of an aliphatic, cyclic polyisocyanate. The urethane-urea compounds are either isolated by concentration, as wax-like substances, or are isolated by dilution with acetone. The insoluble diurea compounds are isolated as crystalline substances, removed by filtration and discarded.

EP 0006252 provides a process for preparing a thixotropic agent and describes urea urethanes that are prepared in aprotic solvents in the presence of lithium chloride by reacting isocyanate adducts with polyamines. The disadvantage of the products prepared in this way is the undefined structure of said urea urethanes due to the preparation process. The preparation process does not provide access to pure monoadducts, but instead forms mixtures of monoadducts and diisocyanates which react with diamines and lead to uncontrolled lengthening of the urea-urethane chain. In the process described, one mol of a diisocyanate is first reacted with one mol of a monoalcohol. This process partly produces the desired NCO-functional monoadducts, but also diadducts without any NCO-functionality. In addition, a proportion of the monomeric diisocyanate remains unreacted. The proportions of these different compounds may vary, depending on the accessibility of the NCO group and the reaction conditions applied, such as temperature and time. All these adducts prepared in this way contain fairly large amounts of unreacted diisocyanate that, during the further reaction with polyamines in the presence of lithium chloride, results in uncontrolled chain extension of the urea urethane and in polymeric ureas. These products then have a tendency to precipitation and can be kept in solution only with the greatest difficulty.

U.S. Pat. No. 6,420,466 describes a process for preparing a thixotropic agent which contains urea-urethanes wherein monohydroxyl compounds are reacted with an excess of toluene diisocyanate, whereby the unreacted portion of the toluene is removed from the reaction mixture and the monoisocyanate adduct obtained is further reacted with diamines in the presence of Lithium salts. The disadvantage of this process is that the subsequent removal of the stoichiometric excess of diisocyanate by vacuum distillation is a complex and expensive process. Also, because of the diurea-urethanes that are deliberately prepared, only a few active urea groups can be incorporated into the molecule and, consequently, the efficiency of these urea-urethanes is limited.

Despite the fact that urea urethane polymers are being commercially prepared and used for many years, there is still an ongoing need to provide a process for preparing urea urethane compounds which does not require a diisocyanate distillation step. It has been a challenge to reduce the free diisocyanate in the first step such that the monoisocyanate adduct, i.e. without free diisocyanates, is formed which when reacted with the diamine in the second step results into a more definite structure of urea urethane polymer.

Thus, it is an object of the presently claimed invention to provide urea urethane compounds that are storage stable and which impart desired thickening effect and thixotropic properties to compositions such as paint and coating formulations. Further, it is another object to pro vide a process for preparing the urea urethane compounds which do not require a diisocyanate distillation step thereby providing a simpler and more economical process, avoiding the disadvantages associated with the presence of free diisocyanate.

### SUMMARY OF THE INVENTION

Surprisingly, it was found that the urea urethane compounds of the present invention pre pared by reacting toluene diisocyanate and a mixture of at least two monohydroxy alcohols in a specific ratio, followed by reaction with at least one diamine, have a good storage stability, and these compounds impart desired thickening effect and thixotropic properties to liquid compositions such as paint and coating formulations, adhesive, paint lacquer, PVC plastisol, ink and cement formulations. Further, the process for preparing the urea urethane compounds does not require a diisocyanate distillation step.

Accordingly, one aspect of the presently claimed invention is a urea urethane compound obtainable by
(i) reacting
   a. toluene diisocyanate with
   b. a mixture of monohydroxy alcohols comprising
   (b1) at least one monohydroxy alcohol of formula (I),

R¹—OH (I),
wherein
R¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, linear or branched, substituted or unsubstituted C₇-C₂₄ aralkyl, and substituted or unsubstituted C₆-C₂₄ aryl,
a radical of formula R¹¹(O—CₙH₂ₙ)ₓ—,
a radical of formula R¹¹[O—C(═O)—CᵥH₂ᵥ]ₓ—, and
a radical of formula R¹¹(O—CₙH₂ₙ)ₓ₋₁[O—C(═O)—CᵥH₂ᵥ]ₓ—,
wherein
R¹¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
n is an integer from 2 to 4,
x is an integer from 1 to 15, and
v is an integer from 4 to 6; and
(b2) at least one monohydroxy alcohol of formula (II)

R²—OH (II),
wherein R² is a radical of formula CₚH₂ₚ₊₁ (O—C_{q}H_{2q})ᵣ—,
p is an integer from 1 to 3,
q is an integer from 2 to 4, and
r is an integer from 1 to 50,
wherein the molar ratio of the at least one monohydroxy alcohol of formula (I) to the at least one monohydroxy alcohol of formula (II) is in the range of 10:1 to 1:10, and
the molar ratio of the total amount of the mixture of monohydroxy alcohols to the toluene diisocyanate is in the range of >1.0:1.0 to ≤1.5:1.0;
to obtain a mixture comprising at least two monoisocyanate adducts;
ii) reacting the mixture comprising at least two monoisocyanate adducts obtained in step (i) with at least one diamine to obtain the urea urethane compound.

Another aspect of the presently claimed invention is a process for preparing the urea urethane compound. The process comprises,
i. introducing toluene diisocyanate into a reactor;
ii. mixing at least one monohydroxy alcohol of formula (I) and at least one monohydroxy alcohol of formula (II) to obtain a mixture comprising monohydroxy alcohols;
iii. adding the mixture obtained in step (ii) into the reactor and reacting the monohydroxy alcohols with toluene diisocyanate to obtain a mixture comprising at least two monoisocyanate adducts;
iv. preparing a mixture by mixing at least one diamine, at least one polar aprotic sol vent and at least one metal salt catalyst; and
v. adding the mixture obtained in step (iv) into the reactor to react with the mixture comprising at least two monoisocyanate adducts obtained in step (iii) to obtain the urea urethane compound.

Another aspect of the presently claimed invention is directed to a liquid composition comprising the urea urethane compound in an amount in the range of ≥0.01 wt.-% to ≤10.0 wt. % based on the total weight of the liquid composition.

Another aspect of the presently claimed invention is directed to a use of the urea urethane compound in liquid compositions as a thixotropic agent for paint and coating formulations, adhesive, paint lacquer, PVC plastisol, ink and cement formulations.

### DETAILED DESCRIPTION OF THE INVENTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Surprisingly, it was found that the urea urethane compounds of the present invention have good storage stability, and these compounds impart desired thickening effect and thixotropic properties to liquid compositions such as paint and coating formulations, adhesive, paint lacquer, PVC plastisol, ink and cement formulations. The urea urethane compounds of the pre sent invention are useful in aqueous formulations as well as organic solvent-based formulations.

Surprisingly, it was found that a urea urethane compound having desired thickening effect and thixotropic properties can be obtained by use of a mixture of appropriately selected monohydroxy alcohols. The thickening effect and thixotropic properties of the urea urethane compound depend upon the monohydroxy alcohol of formula (I) and the monohydroxy alcohol of formula (II) that constitute the mixture of monohydroxy alcohols as well as on their amounts. Thus, by choosing an appropriate monohydroxy alcohol of formula (I) and an appropriate monohydroxy alcohol of formula (II) and suitable amounts thereof, it is possible to obtain a urea urethane compound of having desired thickening effect and thixotropic properties.

The presently claimed invention is directed to urea urethane compounds which are used as an additive in solvent-containing, solvent free and water based paint and coating compositions, for imparting the thixotropic properties to the compositions. The urea urethane compounds are useful for modifying the rheological profile of paint and coating formulations, lacquer, varnish, paper coating, wood coating, adhesive, ink, cosmetic formulations, detergent formulations, textile and drilling muds plaster formulations, PVC plastisol and cement formulations.

Accordingly, one aspect of the presently claimed invention is a urea urethane compound obtainable by
(i) reacting
   a. toluene diisocyanate with
   b. a mixture of monohydroxy alcohols comprising
   (b1) at least one monohydroxy alcohol of formula (I),

R¹—OH (I),
wherein
R¹ is selected from linear or branched, substituted or unsubstituted C₄-C₂₂ alkyl, linear
or branched, substituted or unsubstituted C₄-C₂₂ alkenyl, substituted or unsubstituted
C₆-C₁₂ cycloalkyl, linear or branched, substituted or unsubstituted C₇-C₂₄ aralkyl, and substituted or unsubstituted C₆-C₂₄ aryl,
a radical of formula R¹¹(O—CₙH₂ₙ)ₓ—,
a radical of formula R¹¹[O—C(═O)—CᵥH₂ᵥ]ₓ—, and
a radical of formula R¹¹(O—CₙH₂ₙ)ₓ₋₁[O—C(═O)—CᵥH₂ᵥ]ₓ—,
wherein
   R¹¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
n is an integer from 2 to 4,
x is an integer from 1 to 15, and
v is an integer from 4 to 6; and
(b2) at least one monohydroxy alcohol of formula (II)

R²—OH (II),
wherein R² is a radical of formula C_{P}H₂ₚ₊₁ (O—C_{q}H_{2q})ᵣ—,
p is an integer from 1 to 3,
q is an integer from 2 to 4 and
r is an integer from 1 to 50,
wherein the molar ratio of the at least one monohydroxy alcohol of formula (I) to the at least one monohydroxy alcohol of formula (II) is in the range of 10:1 to 1:10, and
the molar ratio of the total amount of the mixture of monohydroxy alcohols to the toluene diisocyanate is in the range of >1.0:1.0 to ≤1.5:1.0;
to obtain a mixture comprising at least two monoisocyanate adducts; and
ii) reacting the mixture comprising at least two monoisocyanate adducts obtained in step (i) with at least one diamine to obtain the urea urethane compound.

Within context of the presently claimed invention, the term “thixotropic effect”, as used herein, refers to a time-dependent shear thinning property exhibited by a viscous fluid or a gel like product. The product is thick or viscous under static condition and will flow over time when agitated, shear-stressed, or otherwise stressed. Upon removal of the agitation or shear-stress the product again returns to a more viscous state in a time dependent manner.

Within the context of the presently claimed invention, the term alkyl, as used herein, refers to an acyclic saturated aliphatic groups, including linear and branched alkyl saturated hydrocarbon radical denoted by a general formula CₙH₂ₙ₊₁ and wherein n is the number of carbon atoms 1, 2, 3, 4 etc.

Examples of preferred linear unsubstituted alkyl having C₄ to C₂₂ carbon atoms are butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl and docosyl.

Examples of preferred branched unsubstituted alkyl having C₄ to C₂₂ carbon atoms are 1-methyl propyl, 2-methyl propyl, 1-methyl butyl, 2-methyl butyl, 1-methyl pentyl, 2-methyl pentyl, 2-methyl hexyl, 3-methyl hexyl, 1-methyl heptyl, 2-methyl heptyl, 3-methyl heptyl, 1-methyl octyl, 2-methyl octyl, 1-methyl nonyl, 1-ethyl propyl, 1-ethyl butyl, 2-ethyl butyl, 1-ethyl pentyl, 2-ethyl pentyl, 1-ethyl hexyl, 2-ethyl hexyl, 1-ethyl heptyl, 2-ethyl heptyl, 1-ethyl octyl, 2-ethyl octyl, 1-propyl butyl, 1-propyl pentyl, 2-propyl pentyl, 1-propyl hexyl, 2-propyl hexyl, 1-propyl heptyl, 2-propyl heptyl, 3-propyl heptyl, 4-propyl heptyl. 1-butyl pentyl, 1-butyl hexyl and 2-butyl hexyl.

The term substituted alkyl refers to an alkyl radical, wherein a part or all the hydrogen atoms are replaced by substituent/s, preferably the substituents are selected from hydroxy, halogen, cyano, C₁-C₄-alkyl and C₁-C₄-alkoxy.

Within the context of the presently claimed invention, the term alkenyl, as used herein, refers to an acyclic unsaturated aliphatic groups having at least one double bond, including linear and branched alkenyl unsaturated hydrocarbon radical denoted by a general formula CₙH₂ₙ₋₁ and wherein n is the number of carbon atoms 1, 2, 3, 4 etc.

Examples of preferred linear unsubstituted alkenyl having C₄ to C₂₂ carbon atoms are but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-4-enyl, hept-5-enyl, hept-6-enyl, oct-1-enyl, oct-2-enyl, oct-3-enyl, oct-4-enyl, oct-5-enyl, oct-6-enyl, oct-7-enyl, non-1-enyl, non-2-enyl, non-3-enyl, non-4-enyl, non-5-enyl, non-6-enyl, non-7-enyl, non-8-enyl, dec-1-enyl, dec-2-enyl, dec-3-enyl, dec-4-enyl, dec-5-enyl, dec-6-enyl, dec-7-enyl, dec-8-enyl, dec-9-enyl, undec-1-enyl, undec-2-enyl, undec-3-enyl, undec-4-enyl, undec-5-enyl, undec-6-enyl, undec-7-enyl, undec-8-enyl, undec-9-enyl, un-dec-0-enyl, dodec-1-enyl, dodec-2-enyl, dodec-3-enyl, dodec-4-enyl, dodec-5-enyl, dodec-6-enyl, dodec-7-enyl, dodec-8-enyl, dodec-9-enyl, dodec-10-enyl, dodec-11-enyl, tridec-1-enyl, tridec-2-enyl, tridec-3-enyl, tridec-4-enyl, tridec-5-enyl, tridec-6-enyl, tridec-7-enyl, tridec-8-enyl, tridec-9-enyl, tridec-10-enyl, tridec-11-enyl, tridec-12-enyl, tetradec-1-enyl, tetradec-2-enyl, tetradec-3-enyl, tetradec-4-enyl, tetradec-5-enyl, tetradec-6-enyl, tetradec-7-enyl, tetradec-8-enyl, tetradec-9-enyl, tetradec-10-enyl, tetradec-11-enyl, tetradec-12-enyl, tetradec-13-enyl, pentadec-1-enyl, pentadec-2-enyl, pentadec-3-enyl, pentadec-4-enyl, pentadec-5-enyl, pentadec-6-enyl, pentadec-7-enyl, pentadec-8-enyl, pentadec-9-enyl, pentadec-10-enyl, pentadec-11-enyl, pentadec-12-enyl, pentadec-13-enyl, pentadec-14-enyl, hexadec-1-enyl, hexadec-2-enyl, hexadec-3-enyl, hexadec-4-enyl, hexadec-5-enyl, hexadec-6-enyl, hexadec-7-enyl, hexadec-8-enyl, hexadec-9-enyl, hexadec-10-enyl, hexadec-11-enyl, hexadec-12-enyl, hexadec-13-enyl, hexadec-14-enyl, hexadec-15-enyl, heptadec-1-enyl, heptadec-2-enyl, heptadec-3-enyl, heptadec-4-enyl, heptadec-5-enyl, heptadec-6-enyl, heptadec-7-enyl, heptadec-8-enyl, heptadec-9-enyl, heptadec-10-enyl, heptadec-11-enyl, heptadec-12-enyl, heptadec-13-enyl, heptadec-14-enyl, heptadec-15-enyl, heptadec-16-enyl, octadec-1-enyl, octadec-2-enyl, octadec-3-enyl, octadec-4-enyl, octadec-5-enyl, octadec-6-enyl, octadec-7-enyl, octadec-8-enyl, octadec-9-enyl, octadec-10-enyl, octadec-11-enyl, octadec-12-enyl, octadec-13-enyl, octadec-14-enyl, octadec-15-enyl, octadec-16-enyl, octadec-17-enyl, nonadec-1-enyl, nonadec-2-enyl, nonadec-3-enyl, nonadec-4-enyl, nonadec-5-enyl, nonadec-6-enyl, nonadec-7-enyl, nonadec-8-enyl, nonadec-9-enyl, nonadec-10-enyl, nonadec-11-enyl, nonadec-12-enyl, nonadec-13-enyl, nonadec-14-enyl, non-adec-15-enyl, nonadec-16-enyl, nonadec-17-enyl, nonadec-18-enyl, icos-1-enyl, icos-2-enyl, icos-3-enyl, icos-4-enyl, icos-5-enyl, icos-6-enyl, icos-7-enyl, icos-8-enyl, icos-9-enyl, icos-10-enyl, icos-11-enyl, icos-12-enyl, icos-13-enyl, icos-14-enyl, icos-15-enyl, icos-16-enyl, icos-17-enyl, icos-18-enyl, icos-19-enyl, henicos-1-enyl, henicos-2-enyl, henicos-3-enyl, henicos-4-enyl, henicos-5-enyl, henicos-6-enyl, henicos-7-enyl, henicos-8-enyl, henicos-9-enyl, henicos-10-enyl, henicos-11-enyl, henicos-12-enyl, henicos-13-enyl, henicos-14-enyl, henicos-15-enyl, henicos-16-enyl, henicos-17-enyl, henicos-18-enyl, henicos-19-enyl, henicos-20-enyl, docos-1-enyl, docos-2-enyl, docos-3-enyl, docos-4-enyl, docos-5-enyl, docos-6-enyl, docos-7-enyl, docos-8-enyl, docos-9-enyl, docos-10-enyl, docos-11-enyl, docos-12-enyl, docos-13-enyl, docos-14-enyl, docos-15-enyl, docos-16-enyl, docos-17-enyl, docos-18-enyl, docos-19-enyl, docos-20-enyl and docos-21-enyl.

Within the context of the presently claimed invention, the term cycloalkyl, as used herein, refers to a monocyclic and a bicyclic 6 to 12 membered saturated cycloaliphatic groups, including branched cycloalkyl saturated hydrocarbon.

Examples of preferred C₆ to C₁₂ cycloalkyl are cyclohexyl, cycloheptyl, cyclooctyl, cyclononyl, cyclodecyl, cycloundecyl and cycloeodecyl.

Within the context of the presently claimed invention, the term arylalkyl, as used herein, refers to an alkyl group substituted with aryl group. The aryl group is phenyl or naphthyl, preferably phenyl.

Examples of preferred C₇-C₂₄ aralkyl are benzyl, phenylethyl, phenyl-1-propyl, phenyl-2-propyl, phenyl-1-butyl, phenyl-2-butyl, phenyl-1-pentyl, phenyl-1-hexyl, o-tolyl, m-tolyl, p-tolyl, 2,3-, 2,4-, 2,5-, 2,6-, 3,4-, 3,5-xylyl and mesityl.

Within the context of the presently claimed invention, the term “aryl”, as used herein, refers to aromatic carbocyclic rings of 6 to 24 ring members, including both mono-, bi-, and tri-cyclic ring systems. Examples of preferred aryl are indenyl, phenyl and naphthyl.

Within the context of the presently claimed invention, the term “polar aprotic solvent”, as used herein, refers to a solvent made of polar molecules with a comparatively high relative permittivity (or dielectric constant), greater than 15, and a permanent dipole moment, that cannot donate suitably labile hydrogen atoms to form strong hydrogen bonds.

Within context of the presently claimed invention the term “monoisocyanate adduct”, as used herein, refers to an addition product of toluene diisocyanate (TDI) and the monohydroxyl compound of general formula (I) or general formula (II). The monoisocyanate adduct has a free reactive isocyanate groups which react with diamine.

Within context of the presently claimed invention the term “theoretical NCO content”, as used herein, refers to the content of isocyanate (NCO) which is theoretically calculated based on only half amount of the NCO groups from TDI.

In a preferred embodiment, the urea urethane compound is obtainable by
(i) reacting
   a. toluene diisocyanate with
   b. a mixture of monohydroxy alcohols comprising
   (b1) at least one monohydroxy alcohol of formula (I),

R¹—OH (I),
wherein
R¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl, and
(b2) at least one monohydroxy alcohol of formula (II)

R²—OH (II),
wherein R² is a radical of formula C_{P}H₂ₚ₊₁ (O—C_{q}H_{2q})ᵣ—,
p is an integer from 1 to 3,
q is an integer from 2 to 4 and
r is an integer from 1 to 50,
wherein the molar ratio of the at least one monohydroxy alcohol of formula (I) to the at least one monohydroxy alcohol of formula (II) is in the range of 10:1 to 1:10, and
the molar ratio of the total amount of the mixture of monohydroxy alcohols to the toluene diisocyanate is in the range of >1.0:1.0 to ≤1.5:1.0;
to obtain a mixture comprising at least two monoisocyanate adducts;
ii) reacting the mixture comprising at least two monoisocyanate adducts obtained in step (i) with at least one diamine to obtain the urea urethane compound.

In a preferred embodiment, the urea urethane compound is obtainable by
(i) reacting
   a. toluene diisocyanate with
   b. a mixture of monohydroxy alcohols comprising
(b1) at least one monohydroxy alcohol of formula (I),

R¹—OH (I),
wherein
R¹ is selected from
a radical of formula R¹¹ (O—CₙH₂ₙ)ₓ—,
a radical of formula R¹¹ [O—C(═O)—CᵥH₂ᵥ]ₓ—, and
a radical of formula R¹¹ (O—CₙH₂ₙ)ₓ₋₁ [O—C(═O)—CᵥH₂ᵥ]ₓ—,
wherein R¹¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
n is an integer from 2 to 4,
x is an integer from 1 to 15, and
v is an integer from 4 to 6; and
(b2) at least one monohydroxy alcohol of formula (II)

R²—OH (II),
wherein R² is a radical of formula CₚH₂ₚ₊₁ (O—C_{g}H_{2q})ᵣ—,
p is an integer from 1 to 3,
q is an integer from 2 to 4 and
r is an integer from 1 to 50,
wherein the molar ratio of the at least one monohydroxy alcohol of formula (I) to the at least one monohydroxy alcohol of formula (II) is in the range of 10:1 to 1:10, and
the molar ratio of the total amount of the mixture of monohydroxy alcohols to the toluene diisocyanate is in the range of >1.0:1.0 to ≤1.5:1.0;
to obtain a mixture comprising at least two monoisocyanate adducts;
ii) reacting the mixture comprising at least two monoisocyanate adducts obtained in step (i) with at least one diamine to obtain the urea urethane compound.

In a more preferred embodiment, the urea urethane compound is obtainable by
(i) reacting
   a. toluene diisocyanate with
   b. a mixture of monohydroxy alcohols comprising
   (b1) at least one monohydroxy alcohol of formula (I),

R¹—OH (I),
wherein
R¹ is a radical of formula R¹¹ (O—CₙH₂ₙ)ₓ—,
wherein R¹¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
n is an integer from 2 to 4, and
x is an integer from 1 to 15, and
(b2) at least one monohydroxy alcohol of formula (II)

R²—OH (II),
wherein R² is a radical of formula CₚH₂ₚ₊₁ (O—C_{q}H_{2q})ᵣ—,
p is an integer from 1 to 3,
q is an integer from 2 to 4 and
r is an integer from 1 to 50,
wherein the molar ratio of the at least one monohydroxy alcohol of formula (I) to the at least one monohydroxy alcohol of formula (II) is in the range of 10:1 to 1:10, and the molar ratio of the total amount of the mixture of monohydroxy alcohols to the toluene diisocyanate is in the range of >1.0:1.0 to ≤1.5:1.0;
to obtain a mixture comprising at least two monoisocyanate adducts;
ii) reacting the mixture comprising at least two monoisocyanate adducts obtained in step (i) with at least one diamine to obtain the urea urethane compound.

In a preferred embodiment, the toluene diisocyanate is selected from 2,4-toluene diisocyanate and a mixture of 2, 4-toluene diisocyanate and 2, 6-toluene diisocyanate.

In a more preferred embodiment, the toluene diisocyanate is 2,4-toluene diisocyanate.

In a most preferred embodiment, the toluene diisocyanate is a mixture of 2,4-toluene diisocyanate and 2,6-toluene diisocyanate.

2,4-Toluene diisocyanate is available as a commercial product. A mixture of 2,4-toluene diisocyanate and 2,6-toluene diisocyanate having known composition is also available commercially. Mixtures of 2,4-toluene diisocyanate and 2,6-toluene diisocyanate having intermediate composition can be prepared by mixing these two commercially available products.

Surprisingly, it was also observed that the thickening effect and thixotropic properties of the urea urethane compound of the presently claimed invention are enhanced and therefore are different from those of a mixture obtained by physically mixing the urea urethane compounds using single monohydroxy alcohol. Thus, it is clear that the properties of the urea urethane compound obtained according the presently claimed invention are not mere additive proper ties of individual urea urethane compound obtained using single monohydroxy alcohols.

It has been observed that the properties of urea urethane compounds of the presently claimed invention depend upon the monohydroxy alcohol of formula (I) and the monohydroxy alcohol of formula (11) used.

In a more preferred embodiment, R¹ is selected from butyl, pentyl, hexyl, heptyl, octyl, nonyl, decyl, undecyl, dodecyl, 1-methyl propyl, 2-methyl propyl, 1-methyl butyl, 2-methyl butyl, 1-methyl pentyl, 2-methyl pentyl, 2-methyl hexyl, 3-methyl hexyl, 1-ethyl propyl, 1-ethyl butyl, 2-ethyl butyl, cyclohexyl, phenyl, tolyl, xylyl, 4-dodecylphenyl, benzyl and phenylethyl.

In a more preferred embodiment, R¹¹ is selected from butyl, pentyl, hexyl, heptyl, octyl, nonyl, decyl, undecyl, dodecyl, 1-methyl propyl, 2-methyl propyl, 1-methyl butyl, 2-methyl butyl, 1-methyl pentyl, 2-methyl pentyl, 2-methyl hexyl, 3-methyl hexyl, 1-ethyl propyl, 1-ethyl butyl, 2-ethyl butyl, cyclohexyl, phenyl, tolyl, xylyl, 4-dodecylphenyl, benzyl and phenylethyl.

In a preferred embodiment, in formula (I)
R¹¹ is a linear or branched, substituted or unsubstituted C₄-C₂₂ alkyl,
n is an integer from 2 to 4, and
x is an integer from 2 to 10.

In a more preferred embodiment, in formula (I)
R¹¹ is a linear or branched, substituted or unsubstituted C₄-C₁₂ alkyl,
n is an integer from 2 to 3, and
x is an integer from 2 to 6.

In an even more preferred embodiment, in formula (I)
R¹¹ is a linear, unsubstituted C₄-C₁₂ alkyl,
n is an integer from 2 to 3, and
x is an integer from 2 to 6.

In a most preferred embodiment, in formula (I) R¹¹ is n-butyl, n is 2, and x is 3.

In a more preferred embodiment, the at least one monohydroxy alcohol of formula (I) is selected from butyltriglycol, butyldiglycol, butyltetraglycol, butanol, isotridecyl alcohol, oleyl alcohol, Guerbet alcohols containing 8 to 20 carbon atoms, linoleyl alcohol, lauryl alcohol, stearyl alcohol, cyclohexanol, benzyl alcohol, 4-dodecylphenol, ethoxylated triphenylmethanol and ethoxylated 4-dodecylphenol.

In a most preferred embodiment, the at least one monohydroxy alcohol of formula (I) is butyltriglycol ether.

In a preferred embodiment, in formula (II)
p is an integer from 1 to 2,
q is an integer from 2 to 4, and
r is an integer from 5 to 50.

In a more preferred embodiment, in formula (II)
p is an integer from 1 to 2,
q is an integer from 2 to 3, and
r is an integer from 5 to 25.

In an even more preferred embodiment, in formula (II)
p is an integer from 1 to 2,
q is an integer from 2 to 3, and
r is an integer from 5 to 15.

In a most preferred embodiment, in formula (II) p is 1, q is 2, and r is an integer from 5 to 15.

In a most preferred embodiment, the at least one monohydroxy alcohol of formula (II) is methoxy polyethylene glycol (MPEG).

MPEG has varying properties and molecular weight based on the degree of polymerization of the polyethylene glycol, i.e. the value of r.

In a particularly preferred embodiment, the at least one monohydroxy alcohol of formula (II) is methoxy polyethylene glycol (MPEG) having a molecular weight of 350 g/mol, determined according to DIN 55672-1.

In a particularly preferred embodiment, the at least one monohydroxy alcohol of formula (II) is methoxy polyethylene glycol (MPEG) having a molecular weight of 500 g/mol, determined according to DIN 55672-1.

In a particularly preferred embodiment, the at least one monohydroxy alcohol of formula (II) is a mixture of methoxy polyethylene glycol (MPEG) having a molecular weight of 350 g/mol and methoxy polyethylene glycol (MPEG) having a molecular weight of 500 g/mol, both determined according to DIN 55672-1, The molar ratio of MPEG having a molecular weight of 350 g/mol to MPEG having a molecular weight of 500 g/mol is in the range of 1:10 to 10:1.

The molar ratio of the at least one monohydroxy alcohol of formula (I) to the at least one monohydroxy alcohol of formula (II) is important for determining properties of the urea urethane compound of the presently claimed invention. It is found that the thickening effect and thixotropic properties of the urea urethane compound alter upon varying the molar ratio.

In a preferred embodiment, the molar ratio of the at least one monohydroxy alcohol of formula (I) to the at least one monohydroxy alcohol of formula (II) is in the range of 10:1 to 1:10, more preferably in the range of 5:1 to 1:10, even more preferably in the range of 2:1 to 1:6; most preferably in the range of 1.5:1.0 to 1:5.

In a particularly preferred embodiment, the molar ratio of the at least one monohydroxy alcohol of formula (I) to the at least one monohydroxy alcohol of formula (II) is 1:3.

In a particularly preferred embodiment, the molar ratio of the at least one monohydroxy alcohol of formula (I) to the at least one monohydroxy alcohol of formula (II) is 1:4.

The molar ratio of the total amount of the mixture of monohydroxy alcohols to the toluene diisocyanate is greater than 1.0:1.0. This ratio ensures that the toluene diisocyanate is completely reacted to form urea during the reaction. Due to complete consumption of toluene diisocyanate, there is no need for a step of separation, for e.g. by distillation of toluene diisocyanate.

In a preferred embodiment, the molar ratio of the total amount of the mixture of monohydroxy alcohols to the toluene diisocyanate is in the range of ≥1.0:1.0 to ≤1.5:1.0, more preferably in the range of ≥1.005:1.0 to ≤1.45:1.0, even more preferably in the range of ≥1.005:1.0 to ≤1.4:1.0, even more preferably in the range of ≥1.01:1.0 to ≤1.35:1.0, and most prefer ably in the range of ≥1.005:1.0 to ≤1.2:1.0.

In a particularly preferred embodiment, the molar ratio of the total amount of the mixture of monohydroxy alcohols to the toluene diisocyanate is 1.05:1.0.

In a preferred embodiment, the at least one diamine is selected from diamines of formula (IIIa), (IIIb), (IIIc), (IIId) and (IIIe);

H₂N—R³—NH₂ (IIIa),
wherein R³ is —C_{y}H_{2y}— and y is an integer from 2 to 12,

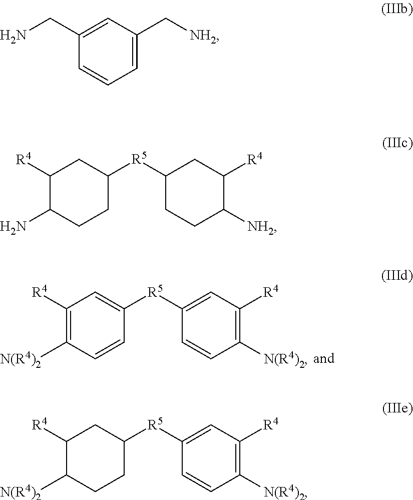

wherein, in formula (IIIc), formula (IIId) and formula (IIIe), R⁴ is identical or different and is selected from H, CH₃—, —C₂H₅— and C₃H₇—, and R⁵ is selected from —CH₂—, —C₂H₄—, —C₃H₆— and —C₆H₁₂—.

In a preferred embodiment, the at least one diamine is selected from the group consisting of 4,4-diamino-diphenylmethane, 3,3-dimethyl-4,4-diamino-diphenylmethane, 2,2-bis(4-aminocyclohexyl)-propane, N,N-dimethyl-4,4-diaminodiphenylmethane, (3-methyl-4-aminocylcohexyl)-(3-methyl-4-aminophenyl)-methane, m-xylylenediamine, p-xylylenediamine, ethylenediamine, hexamethylenediamine, 4,4-methylenebis(cyclohexylamine) and 1,12-diaminododecane.

In a most preferred embodiment, the at least one diamine is m-xylylenediamine.

In a preferred embodiment, the urea urethane compound of the presently claimed invention has a weight average molecular weight in the range of ≥300 g/mol to ≤5000 g/mol, deter mined according to DIN 55672-2.

In a more preferred embodiment, the urea urethane compound of the presently claimed invention has a weight average molecular weight in the range of ≥1000 g/mol to ≤4000 g/mol; and most preferably in the range of ≥2000 g/mol to ≤3500 g/mol, determined according to DIN 55672-2.

In a preferred embodiment, the urea urethane compound of the presently claimed invention has a polydispersity index in the range of 1.0 to 3.0; more preferably in the range of 1.0 to 2.0; and most preferably in the range of 1.1 to 1.8.

Another aspect of the presently claimed invention is directed to a process for preparing a urea urethane compound. The process comprises the following steps.
i. introducing toluene diisocyanate into a reactor;
ii. mixing at least one monohydroxy alcohol of formula (I) and at least one monohydroxy alcohol of formula (II) to obtain a mixture comprising monohydroxy alcohols;
iii. adding the mixture obtained in step (ii) into the reactor and reacting the monohydroxy alcohols with toluene diisocyanate to obtain a mixture comprising at least two monoisocyanate adducts;
iv. preparing a mixture by mixing at least one diamine, at least one polar aprotic solvent and at least one metal salt catalyst; and
v. adding the mixture obtained in step (iv) into the reactor to react with the mixture comprising at least two monoisocyanate adducts obtained in step (iii) to obtain the urea urethane compound.

In a preferred embodiment, step (i) further comprises introducing into the reactor at least one solvent selected from the group consisting of ethyl acetate, acetone and methylethylketone; and more preferably ethyl acetate.

In a preferred embodiment, step (i) further comprises pre-mixing toluene diisocyanate with at least one solvent and introducing the mixture of toluene diisocyanate and the at least one solvent into the reactor; wherein the at least one solvent selected from the group consisting of ethyl acetate, acetone and methylethylketone; and more preferably ethyl acetate.

In a preferred embodiment, the mixture comprising monohydroxy alcohols obtained in step (ii) further comprises at least one catalyst selected from the group consisting of p-toluenesulfonic acid, H₂SO₄, HCl and acetic acid; and more preferably p-toluenesulfonic acid.

In a preferred embodiment, the mixture comprising monohydroxy alcohols obtained in step (ii) is added into the reactor over a time period in the range of ≥1 hour to ≤50 hours; more preferably ≥2 hour to ≤30 hours; even more preferably ≥3 hour to ≤20 hours; and most preferably ≥3 hour to ≤15 hours.

In a preferred embodiment, in step (iii) the reaction of the monohydroxy alcohols with toluene diisocyanate is carried out at a temperature in the range of ≥20° C. to ≤60° C.; more preferably ≥25° C. to ≤60° C.; even more preferably ≥30° C. to ≤50° C.; and most preferably ≥40° C. to ≤50° C.

In a preferred embodiment, the at least one polar aprotic solvent is selected from the group consisting of dimethyl sulfoxide, N,N-dimethylformamide, N,N-dimethylacetamide, N-methylpyrrolidone, N-ethylpyrrolidone, N-propylpyrrolidone, N-butylpyrrolidone, N,N,N′,N′-tetramethylurea, hexamethyl-phosphoric acid triamide and methyl 5-(dimethylamino)-2-methyl-5-oxopentanoate (N-butylbutyrolactam); more preferably dimethyl sulfoxide, N,N-dimethylformamide, N-methylpyrrolidone, N-butylpyrrolidone, and methyl 5-(dimethylamino)-2-methyl-5-oxopentanoate (N-butylbutyrolactam); and most preferably dimethyl sulfoxide, N-butylpyrrolidone, and methyl 5-(dimethylamino)-2-methyl-5-oxopentanoate.

In a preferred embodiment, the metal salt catalyst is selected from the group consisting of lithium chloride, lithium nitrate, lithium bromide and dioctyl sulfosuccinate sodium salt; and more preferably lithium nitrate and dioctyl sulfosuccinate sodium salt.

In a preferred embodiment, the mixture obtained in step (iv) is added into the reactor over a time period in the range of ≥1 hours to ≤20 hours, more preferably ≥1 hours to ≤15 hours; even more preferably ≥2 hours to ≤10 hours, and most preferably ≥3 hours to ≤10 hours.

In a preferred embodiment, in step (v) the reaction of at least one diamine with the at least two monoisocyanate adducts is carried out at a temperature in the range of ≥20° C. to ≤100° C., more preferably ≥40° C. to ≤100° C., and even most preferably ≥50° C. to ≤90° C.

In a preferred embodiment, the molar ratio of the metal salt catalyst to the at least one diamine is in the range of 0.3:1.0 to 1.0:1.5, and more preferably in the range of 0.5:1.0 to 1.0:1.0.

In a preferred embodiment, in step (iii), the NCO content via titration is lower than 110%, preferably lower than 105%, of the “theoretical NCO content”. The “theoretical NCO content” is calculated based on only half amount of the NCO groups from TDI starting material re acted with the mixture of R¹—OH and R²-0H.

In a preferred embodiment, in step (v), the NCO content is 0.

Thus, the toluene diisocyanate is completely reacted to form urea during the reaction. Due to complete consumption of toluene diisocyanate, there is no need for a step of separation, for e.g. by distillation of toluene diisocyanate.

Another aspect of the presently claimed invention is directed to a liquid composition comprising the urea urethane compound of the presently claimed invention or obtained according to the process of the presently claimed invention in an amount in the range of ≥0.01 wt.-% to ≤10.0 wt.-% based on the total weight of the liquid composition.

In a preferred embodiment, the liquid composition comprises the urea urethane compound in an amount in the range of ≥0.1 wt.-% to 7.0≤wt.-%, even more preferably in the range from ≥0.1 wt.-% to ≤5.0 wt.-%, and most preferably in the range from ≥0.1 wt.-% to ≤3.0 wt.-% based on the total weight of the liquid composition.

In a preferred embodiment, the liquid composition further comprises at least one component selected from pigment pastes, binders, fillers, solvents, defoamers, neutralising agent, wet ting agent, pigment dispersing agents, preservatives and water.

In a preferred embodiment, the liquid composition is a paint, water based coating formulation, solvent based coating formulation, lacquer, varnish, paper coating, wood coating, adhesive, ink, cosmetic formulation, detergent formulation, textile, drilling muds plaster formulation, cement composition, formulation for plasterboard, for hydraulic binders such as mortar formulations, formulation for ceramics and for leather.

Another aspect of the presently claimed invention is directed to a use of the urea urethane compound of the presently claimed invention or obtained according to the process of the presently claimed invention as a thixotropic agent for paint and coating formulations, adhesive, paint lacquer, PVC plastisol, ink and cement formulations.

In a preferred embodiment the liquid composition is a water based or solvent based paint and coating formulation. Paints and coating compositions for the purposes of the invention are those, which are applied from liquid phase to a substrate and, with the formation of a film, form a protective or functional and/or decorative surface. By substrates are meant, for example, wood, metals, polymeric films, polymeric parts, paper, leather, fingernails and toenails, and construction materials, such as masonry, concrete and plasters, for example. The coating materials in question may be unpigmented, pigmented or dye-containing coating materials, which may in turn contain different kinds of binders, alone or in a mixture, along with other additives such as filler, binders, neutralizing agents, pigments, defoamers, wetting agents, pigment dispersing agents etc.

A few examples of the additives used in the coating formulations are:

### Fillers

Suitable fillers are, for example, organic or inorganic particulate materials such as, for example, calcium carbonates and silicates, and also inorganic fiber materials such as glass fibers. Organic fillers as well, such as carbon fibers, and mixtures of organic and inorganic fillers, such as mixtures of glass fibers and carbon fibers or mixtures of carbon fibers and inorganic fillers, for example, may find application.

### Binders

Suitable binders are the ones customarily used, for example the ones described in 30 Ullmann's Encyclopaedia of Industrial Chemistry, 5th Edition, Vol. A18, pp. 368-426, VCH, Weinheim 1991, Germany. In general, the film-forming binder is based on a thermoplastic or thermosetting resin. Examples thereof are alkyd, acrylic, unsaturated or saturated polyester resin, acrylate and methacrylate resins, nitrocellulose, cellulose acetobutyrate, alkyd-amino resins, alkyd resins, melamine resins, urea resins, silicone resins, phenolic, melamine, epoxy and polyurethane resins and mixtures thereof. Also resins curable by radiation or air-drying resins can be used. Binders may also be derived from polyvinylalcohol and polyvinylbutyral. Binders include latex polymers made by emulsion polymerization. For architectural coatings especially preferred latex polymers are based on acrylic emulsion polymers, styrene-acrylic emulsion polymers, vinyl acetate-acrylic emulsion polymers or emulsion polymers based on ethylene and vinyl acetate.

### Pigments

Organic or inorganic pigments are suitable as additives. Examples of organic pigments are color pigments and mother-of-pearl-like pigments such as azo, disazo, naphthol, benzimidazolone, azo condensation, metal complex, isoindolinone, quinophthalone, and dioxazine pigments, polycyclic pigments such as indigo, thioindigo, quinacridones, phthalocyanines, perylenes, perinones, anthraquinones, e.g., aminoanthraquinones or hydroxyanthraquinones, anthrapyrimidines, indanthrones, flavanthrones, pyranthrones, anthanthrones, isoviolanthrones, diketopyrrolopyrroles, and also carbazoles, for example, carbazole violet, and the like. Other examples of organic pigments can be found in the following monograph: W. Herbst, K. Hunger, “Industrielle Organische Pigmente”, 2^{nd} edition, 1995, VCH Verlagsgesellschaft, ISBN: 3-527-28744-2. Examples of inorganic pigments are titanium dioxide, metallic flakes, such as aluminum and also aluminum oxide, iron (III) oxide, chromium (III) oxide, titanium (IV) oxide, zirconium(IV)oxide, zinc oxide, zinc sulfide, zinc phosphate, mixed metal oxide phosphates, molybdenum sulfide, cadmium sulfide, graphite, vanadates such as bismuth vanadate, chromates, such as lead(IV) chromates, molybdates such as lead(IV) molybdate, and mixtures thereof.

### Neutralizing Agent

Suitable neutralizing agents are inorganic bases, organic bases, and combinations thereof. Examples of inorganic bases include but are not limited to the alkali metal hydroxides (especially lithium, sodium, potassium, magnesium, and ammonium), and alkali metal salts of in organic acids, such as sodium borate (borax), sodium phosphate, sodium pyrophosphate, and the like; and mixtures thereof. Examples of organic bases include but are not limited to triethanolamine (TEA), diisopropanolamine, triisopropanolamine, aminomethyl propanol (2-Amino-2-methyl-1-propanol), dodecylamine, cocamine, oleamine, morpholine, triamylamine, triethylamine, tetrakis(hydroxypropyl)ethylenediamine, L-arginine, methyl glucamine, isopropylamine, aminomethyl propanol, tromethamine (2-amino 2-hydroxymethyl-1,3-propanediol), and PEG-15 cocamine. Alternatively, other alkaline materials can be used alone or in combination with the above-mentioned inorganic and organic bases.

### Defoamers

Suitable defoamers are selected from the wide range of defoamer used such as silicone based defoamers, emulsion defoamers, star polymer based defoamers, powder defoamers, oil based defoamers.

The presently claimed invention offers one or more of the following advantages:
1. A stable urea urethane compound as an additive in paint and coating formulations for imparting thixotropic effects to the formulations.
2. A stable urea urethane compound as an additive in aqueous as well as organic solvent based paint and coating formulations to impart thixotropic effects to the formulations.
3. A simple and economical process for preparation of urea urethane compounds as no diisocyanate distillation step is required.

In the following, there are provided a list of embodiments to further illustrate the present disclosure without intending to limit the disclosure to specific embodiments listed below.
1. A urea urethane compound obtainable by
(i) reacting
   a. toluene diisocyanate with
   b. a mixture of monohydroxy alcohols comprising
   (b1) at least one monohydroxy alcohol of formula (I),

R¹—OH (I),
wherein
R¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
a radical of formula R¹¹(O—C₆H₂ₙ)ₓ—,
a radical of formula R¹¹O—C(═O)—CᵥH₂ᵥ]ₓ—, and
a radical of formula R¹¹(O—CₙH₂ₙ)ₓ₋₁[O—C(═O)—CᵥH₂ᵥ]ₓ—,
wherein
R¹¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
n is an integer from 2 to 4,
x is an integer from 1 to 15, and
v is an integer from 4 to 6; and
(b2) at least one monohydroxy alcohol of formula (II)

R²—OH (II),
wherein R² is a radical of formula C_{P}H₂ₚ₊₁ (O—C_{q}H_{2q})ᵣ—,
p is an integer from 1 to 3,
q is an integer from 2 to 4 and
r is an integer from 1 to 50,
wherein the molar ratio of the at least one monohydroxy alcohol of formula (I) to the at least one monohydroxy alcohol of formula (II) is in the range of 10:1 to 1:10, and
the molar ratio of the total amount of the mixture of monohydroxy alcohols to the toluene diisocyanate is in the range of >1.0:1.0 to ≤1.5:1.0;
to obtain a mixture comprising at least two monoisocyanate adducts;
ii) reacting the mixture comprising at least two monoisocyanate adducts obtained in step (i) with at least one diamine to obtain the urea urethane compound.
2. The urea urethane compound according to embodiment 1, wherein the toluene diisocyanate is selected from 2, 4-toluene diisocyanate and a mixture of 2, 4-toluene diisocyanate and 2, 6-toluene diisocyanate.
3. The urea urethane compound according to any of embodiments 1 to 2, wherein in formula (I)
   R¹¹ is a linear or branched, substituted or unsubstituted C₄-C₂₂ alkyl,
   n is an integer from 2 to 4, and
   x is an integer from 2 to 10.
4. The urea urethane compound according to any of embodiments 1 to 3, wherein in formula (II)
   p is an integer from 1 to 2,
   q is an integer from 2 to 4, and
   r is an integer from 5 to 50.
5. The urea urethane compound according to any of embodiments 1 to 4, wherein the at least one monohydroxy alcohol of formula (I) is selected from butyltriglycol, butyldiglycol, butyltetraglycol, butanol, isotridecyl alcohol, oleyl alcohol, Guerbet alcohols containing 8 to 20 carbon atoms, linoleyl alcohol, lauryl alcohol, stearyl alcohol, cyclohexanol, benzyl alcohol, 4-dodecylphenol, ethoxylated triphenylmethanol and ethoxylated 4-dodecylphenol.
6. The urea urethane compound according to any of embodiments 1 to 5, wherein the at least one monohydroxy alcohol of formula (II) is methoxy polyethylene glycol.
7. The urea urethane compound according to any of embodiments 1 to 6, wherein the molar ratio of the total amount of the mixture of monohydroxy alcohols to the toluene diisocyanate is in the range of >1.0:1.0 to <1.5:1.0.
8. The urea urethane compound according to any of embodiments 1 to 7, wherein the at least one diamine is selected from diamines of formula (IIIa), (IIIb), (IIIc), (IIId) and (IIIe);

H₂N—R³—NH₂ (IIIa),
wherein R³ is —C_{y}H_{2y}— and y is an integer from 2 to 12,

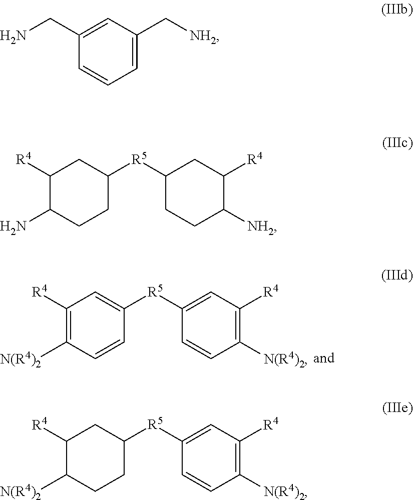

wherein, in formula (IIIc), formula (IIId) and formula (IIIe), R⁴ are identical or different and are selected from H, CH₃—, —C₂H₅— and C₃H₇—, and R⁵ is selected from —CH₂—, —C₂H₄—, —C₃H₆— and —C₆H₁₂—.
9. The urea urethane compound according to any of embodiments 1 to 8, wherein the at least one diamine is selected from the group consisting of 4,4-diamino-diphenylmethane, 3,3-dimethyl-4,4-diamino-diphenylmethane, 2,2-bis(4-aminocyclohexyl)-propane, N,N-dimethyl-4,4-diaminodiphenylmethane, (3-methyl-4-aminocylcohexyl)-(3-methyl-4-aminophenyl)-methane, m-xylylenediamine, p-xylylenediamine, ethylenediamine, hexamethylenediamine, 4,4-methylenebis(cyclohexylamine) and 1,12-diaminododecane.
10. The urea urethane compound according to any of embodiments 1 to 9 having a weight average molecular weight in the range of ≥300 g/mol to ≤5000 g/mol, determined according to DIN 55672-2.
11. The urea urethane compound according to any of embodiments 1 to 10 having a polydispersity index in the range of 1.0 to 3.0.
12. A process for preparing a urea urethane compound according to any of embodiments 1 to 11 comprising:
   i. introducing toluene diisocyanate into a reactor;
   ii. mixing at least one monohydroxy alcohol of formula (I) and at least one monohydroxy alcohol of formula (II) to obtain a mixture comprising monohydroxy alcohols;
   iii. adding the mixture obtained in step (ii) into the reactor and reacting the monohydroxy alcohols with toluene diisocyanate to obtain a mixture comprising at least two monoisocyanate adducts;
   iv. preparing a mixture by mixing at least one diamine, at least one polar aprotic solvent and at least one metal salt catalyst; and
   v. adding the mixture obtained in step (iv) into the reactor to react with the mixture comprising at least two monoisocyanate adducts obtained in step (iii) to obtain the urea urethane compound.
13. The process according to embodiment 12, wherein the mixture comprising monohydroxy alcohols obtained in step (ii) further comprises at least one catalyst selected from the group consisting of p-toluenesulfonic acid, H₂SO₄, HCl and acetic acid.
14. The process according to embodiment 12 or 13, wherein the mixture comprising monohydroxy alcohols obtained in step (ii) is added into the reactor over a time period in the range of ≥1 hour to ≤50 hours.
15. The process according to any of embodiments 12 to 14, wherein in step (iii) the reaction of the monohydroxy alcohols with toluene diisocyanate is carried out at a temperature in the range of ≥20° C. to ≤60° C.
16. The process according to any of embodiments 12 to 15, wherein the at least one polar aprotic solvent is selected from the group consisting of dimethyl sulfoxide, N,N-dimethylformamide, N,N-dimethylacetamide, N-methylpyrrolidone, N-ethylpyrrolidone, N-propylpyrrolidone, N-butylpyrrolidone, N,N,N′,N′-tetramethylurea, hexamethyl-phosphoric acid triamide and methyl 5-(dimethylamino)-2-methyl-5-oxopentanoate.
17. The process according to any of embodiments 12 to 16, wherein the metal salt catalyst is selected from the group consisting of lithium chloride, lithium nitrate, lithium bromide, and dioctyl sulfosuccinate sodium salt.
18. The process according to any of embodiments 12 to 17, wherein the mixture obtained in step (iv) is added into the reactor over a time period in the range of ≥1 hour to ≤20 hours.
19. The process according to any of embodiments 12 to 18, wherein in step (v) the reaction of at least one diamine with the at least two monoisocyanate adducts is carried out at a temperature in the range of ≥20° C. to ≤100° C.
20. The process according to any of embodiments 12 to 19, wherein the molar ratio of the metal salt catalyst to the at least one diamine is in the range of 0.3:1.0 to 1.0:1.5.
21. A liquid composition comprising the urea urethane compound obtained according to any of embodiments 1 to 11 or according to the process of any of embodiments 12 to 20 in an amount in the range of ≥0.01 wt.-% to ≤10.0 wt.-% based on the total weight of the liquid composition.
22. The liquid composition according to embodiment 21 further comprising at least one component selected from pigment pastes, binders, fillers, solvents, defoamers, neutralising agent, wetting agent, pigment dispersing agents, preservatives and water.
23. The liquid composition according to embodiment 21 or 22, wherein the composition is a paint, water based coating formulation, solvent based coating formulation, lacquer, varnish, paper coating, wood coating, adhesive, ink, cosmetic formulation, detergent formulation, textile, drilling muds plaster formulation, cement composition, formulation for plasterboard, for hydraulic binders such as mortar formulations, formulation for ceramics and for leather.
24. Use of the urea urethane compound obtained according to any of embodiments 1 to 11 or according to the process of any of embodiments 12 to 20 in liquid compositions as a thixotropic agent for paint and coating formulations, adhesive, paint lacquer, PVC plastisol, ink and cement formulations.

While the presently claimed invention has been described in terms of its specific embodiments, certain modifications and equivalents will be apparent to those skilled in the art and are intended to be included within the scope of the presently claimed invention.

### Examples

The presently claimed invention is illustrated in detail by non-restrictive working examples which follow. More particularly, the test methods specified hereinafter are part of the general disclosure of the application and are not restricted to the specific working examples.

### Materials

Lupranat® T80A also referred to as “TDI T80” is toluene diisocyanate which is an 80%
20% mixture of the 2,4 and 2,6 isomers of toluene diisocyanate, is available from BASF SE.

Desmodur®T100SP also referred to as “TDI T100” is pure 2,4-toluene diisocyanate (TDI) is available from Covestro AG.

TDI T98, T97, T96, T95 and the like are blends obtained by mixing Desmodur®T100SP and Lupranat®T80A in calculated amounts. For example, T98 is obtained by mixing Desmodur®T100SP and Lupranat®T80A in the weight ratio of 90:10, and T90 is obtained by mixing Desmodur®T100SP and Lupranat®T80A with the weight ratio of 50:50.

### Methods

### Viscosity

The viscosity of a sample was determined either by a rheometer in accordance to DIN 53019 or calculated from values of a brabender plastograph.

### NCO Content

Theoretical NCO content was calculated (as follows:

Theoretical NCO content=0.2411*M_{TDI}/(M_{TDI}+M_{R—OH}+Mₛₒₗᵥₑₙₜ)*100%
M_{TDI}: Weight of TDI charged in reactor
M_{R—OH}: Weight of mixture of R¹—OH and R²—OH charged in reactor
Mₛₒₗᵥₑₙₜ: Weight of solvent (optional) charged in reactor

### Molecular Weight and Polydispersity Index (POI)

The molecular weight and polydispersity index were determined in accordance to DIN 55672-1 and DIN 55672-2.

### I. Preparation of Urea Urethane Compounds

### Example 1: Preparation of Urea Urethane Compound U1

In a 5-necked 200 ml Sulfier flask with an overhead stirrer, thermometer, reflux condenser and septum, a mixture containing 17.4 g of TDI T90 (100 mmol) and 10 g of ethyl acetate was purged with nitrogen. 10.8 g Butyltriglycol ether (52.3 mmol) and 19.0 g of poly(ethylene glycol) methyl ether (MW of 350 g/mol 54.3 mmol) were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 57 g dimethyl sulfoxide were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO containt was 0.

Ethyl acetate was distilled out under reduced pressure to obtain U1 as a yellowish transparent liquid that was free flowing at room temperature.

The molecular weight of U1 was 24008/mol as determined by GPC (according to DIN 55672-2, N,N-Dimethylacetamide, 1 mL/min, PMMA standard); and its PDI was 1.2. The urea urethane compound U1 remained stable (no precipitation or gel formation) upon storage (>2 months) under ambient conditions.

### Example 2: Preparation of Urea Urethane Compound U2

In a 5-necked 200 ml Sulfier flask with an overhead stirrer, thermometer, reflux condenser and septum, a mixture containing 17.4 g of TDI T85 (100 mmol) and 10 g of ethyl acetate was purged with nitrogen. 5.4 g Butyltriglycol ether (26.2 mmol), 39.0 g of poly(ethylene glycol) methyl ether (MW of 500 g/mol 78.0 mmol) and 0.03 g p-toluenesulfonic acid were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 70 g dimethyl sulfoxide were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO content was 0.

Ethyl acetate was distilled out under reduced pressure to obtain U2 as a yellowish transparent liquid that was free flowing at room temperature.

The molecular weight of U2 was 26008/mol as determined by GPC (according to DIN 55672-2, N,N-Dimethylacetamide, 1 mL/min, PMMA standard); and its PDI was 1.3.

The urea urethane compound U2 remained stable (no precipitation or gel formation) upon storage (>2 months) under ambient conditions.

### Example 3: Preparation of Urea Urethane Compound U3

In a 5-necked 200 ml Sulfier flask with an overhead stirrer, thermometer, reflux condenser and septum, a mixture containing 17.4 g of TDI T95 (100 mmol) and 10 g of ethyl acetate was purged with nitrogen. 4.3 g Butyltriglycol ether (20.8 mmol), 29.0 g of poly(ethylene glycol) methyl ether (MW of 350 g/mol, 82.8 mmol) were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 60 g dimethyl sulfoxide were mixed at room temperature and the mixture was to the reaction mixture comprising a mixture of monoisocyanate adducts at 60° C. over a time period of 5 hours. The resulting mixture was heated to 80° C. and stirred at the same temperature until the NCO content was 0.

Ethyl acetate was distilled out under reduced pressure to obtain U3 as a yellowish transparent liquid that was free flowing at room temperature.

The molecular weight of U3 was 28008/mol as determined by GPC (according to DIN 55672-2, N,N-Dimethylacetamide, 1 mL/min, PMMA standard); and its PDI was 1.2.

The urea urethane compound U3 remained stable (no precipitation or gel formation) upon storage (>2 months) under ambient conditions.

### Example 4: Preparation of Urea Urethane Compound U4

In a 5-necked 200 ml Sulfier flask with an overhead stirrer, thermometer, reflux condenser and septum, a mixture containing 17.4 g of TDI T100 (100 mmol) and 10 g of ethyl acetate was purged with nitrogen. 4.3 g Butyltriglycol ether (20.8 mmol), 15.0 g of poly(ethylene glycol) methyl ether (MW of 350 g/mol 42.8 mmol), 21.0 g of poly(ethylene glycol) methyl ether (MW of 500 g/mol 42.0 mmol) and 0.03 g p-toluenesulfonic acid were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 65 g dimethyl sulfoxide were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO content was 0.

Ethyl acetate was distilled out under reduced pressure to obtain U4 as a yellowish transparent liquid that was free flowing at room temperature.

The molecular weight of U4 was 29008/mol as determined by GPC (according to DIN 55672-2, N,N-Dimethylacetamide, 1 mL/min, PMMA standard); and its PDI was 1.3.

The urea urethane compound U4 remained stable (no precipitation or gel formation) upon storage (>2 months) under ambient conditions.

### Example 5: Preparation of Urea Urethane Compound U5

In a 5-necked 200 ml Sulfier flask with an overhead stirrer, thermometer, reflux condenser and septum, a mixture containing 17.4 g of TDI T88 (100 mmol) and 10 g of ethyl acetate was purged with nitrogen. 4.3 g Butyltriglycol ether (20.8 mmol), 18 g of poly(ethylene glycol) methyl ether (MW of 350 g/mol 51.4 mmol), and 16 g of poly(ethylene glycol) methyl ether (MW of 500 g/mol 32.0 mmol) were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 60 g dimethyl sulfoxide were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO content was 0%.

Ethyl acetate was distilled out under reduced pressure to obtain U5 as a yellowish transparent liquid that was free flowing at room temperature.

The molecular weight of U5 was 27008/mol as determined by GPC (according to DIN 55672-2, N,N-Dimethylacetamide, 1 mL/min, PMMA standard); and its PDI was 1.3.

The urea urethane compound U5 remained stable (no precipitation or gel formation) upon storage (>2 months) under ambient conditions.

### Example 6: Preparation of Urea Urethane Compound U6

In a 5-necked 200 ml Sulfier flask with an overhead stirrer, thermometer, reflux condenser and septum, a mixture containing 17.4 g of TDI T100 (100 mmol) and 10 g of ethyl acetate was purged with nitrogen. 5.4 g Butyltriglycol ether (26.2 mmol), 13.8 g of poly(ethylene glycol) methyl ether (MW of 350 g/mol 39.4 mmol), 19.7 g of poly(ethylene glycol) methyl ether (MW of 500 g/mol 38.4 mmol) and 0.03 g p-toluenesulfonic were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 65 g dimethyl sulfoxide were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO content was 0.

Ethyl acetate was distilled out under reduced pressure to obtain U6 as a yellowish transparent liquid that was free flowing at room temperature.

The molecular weight of U6 was 29008/mol as determined by GPC (according to DIN 55672-2, N,N-Dimethylacetamide, 1 mL/min, PMMA standard); and its PDI was 1.3.

The urea urethane compound U6 remained stable (no precipitation or gel formation) upon storage (>2 months) under ambient conditions.

### Example 7: Preparation of Urea Urethane Compound U7

In a 5-necked 200 ml Sulfier flask with an overhead stirrer, thermometer, reflux condenser and septum, a mixture containing 17.4 g of TDI T95 (100 mmol) and 10 g of ethyl acetate was purged with nitrogen. 4.3 g Butyltriglycol ether (20.8 mmol), 15 g of poly(ethylene glycol) methyl ether (MW of 350 g/mol 42.8 mmol), and 21 g of poly(ethylene glycol) methyl ether (MW of 500 g/mol 42.0 mmol) mixed with 0.03 g p-toluenesulfonic were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 65 g N-methylpyrrolidone were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO content was 0.

Ethyl acetate was distilled out under reduced pressure to obtain U7 as a yellowish transparent liquid that was free flowing at room temperature.

The molecular weight of U7 was 25008/mol as determined by GPC (according to DIN 55672-2, N,N-Dimethylacetamide, 1 mL/min, PMMA standard); and its PDI was 1.3.

The urea urethane compound U7 remained stable (no precipitation or gel formation) upon storage (>2 months) under ambient conditions.

### Example 8: Preparation of Urea Urethane Compound U8

In a 5-necked 200 ml Sulfier flask with an overhead stirrer, thermometer, reflux condenser and septum, a mixture containing 17.4 g of TDI T100 (100 mmol) and 10 g of ethyl acetate was purged with nitrogen. 5.4 g Butyltriglycol ether (26.2 mmol), 13.8 g of poly(ethylene glycol) methyl ether (MW of 350 g/mol 39.4 mmol), 19.7 g of poly(ethylene glycol) methyl ether (MW of 500 g/mol 39.4 mmol) and 0.03 g p-toluenesulfonic acid were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

2.6 g Lithium nitrate, 6.2 g of m-xylenediamine (46 mmol) and 65 g methyl 5-(dimethylamino)-2-methyl-5-oxopentanoate were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO content was 0.

Ethyl acetate was distilled out under reduced pressure to obtain U8 as a yellowish transparent liquid that was free flowing at room temperature.

The molecular weight of U8 was 27008/mol as determined by GPC (according to DIN 55672-2, N,N-Dimethylacetamide, 1 mL/min, PMMA standard); and its PDI was 1.3.

The urea urethane compound U8 remained stable (no precipitation or gel formation) upon storage (>2 months) under ambient conditions.

### Example 9: Preparation of Urea Urethane Compound U9

In a 5-necked 200 ml Sulfier flask with an overhead stirrer, thermometer, reflux condenser and septum, a mixture containing 17.4 g of TDI T85 (100 mmol) and 10 g of ethyl acetate was purged with nitrogen. 5.4 g Butyltriglycol ether (26.2 mmol), 39 g of poly(ethylene glycol) methyl ether (MW of 500 g/mol 78.0 mmol) and 0.03 g p-toluenesulfonic acid were mixed and the mixture of alcohols was fed to the reactor over a time period of 10 hours at 45° C. The resultant mixture was stirred at 45° C. until the NCO value (NCO %) was stable, to obtain a reaction mixture comprising a mixture of monoisocyanate adducts.

3.0 g Dioctyl sulfosuccinate sodium salt, 6.2 g of m-xylenediamine (46 mmol) and 70 g dimethyl sulfoxide were mixed at room temperature and the mixture was fed to the reaction mixture comprising a mixture of monoisocyanate adducts at 60° C. over a time period of 5 hours. The resulting mixture was heated to 80° C. and stirred at the same temperature until the NCO content was 0.

Ethyl acetate was distilled out under reduced pressure to obtain U9 as a yellowish transparent liquid that was free flowing at room temperature.

The molecular weight of U9 was 2950 g/mol as determined by GPC (according to DIN 55672-2, N,N-Dimethylacetamide, 1 mL/min, PMMA standard); and its PDI was 1.2.

The urea urethane compound U9 remained stable (no precipitation or gel formation) upon storage (>1 month) under ambient conditions.

### II. Comparative Examples

Two urea urethane compounds (C1 and C2) were prepared by using only one alcohol; in the first case butyltriglycol ether (BGE) and in the second case poly(ethylene glycol) methyl ether was used.

Additionally, a third urea urethane compound was obtained by physically mixing the first and second urea urethane compounds obtained above.

### Comparative Example 1: Preparation of Urea Urethane Compound (C1) Using Butyltriglycol Ether as Single Alcohol

The urea urethane compound was prepared using butyltriglycol ether (BGE) as a single alcohol by the procedure disclosed in Example 7 of WO2019096611A1.

### Comparative Example 2: Preparation of Urea Urethane Compound (C₂) Using Poly(Ethylene Glycol) Methyl Ether as Single Alcohol

In a 5-necked 200 ml Sulfier flask with an overhead stirrer, thermometer, reflux condenser and septum, a mixture containing 17.4 g of TDI T90 (100 mmol) and 10 g of ethyl acetate was purged with nitrogen. 38.5 g of Poly(ethylene glycol) methyl ether (MW of 350 g/mol, 110 mmol) was fed to the reactor over a time period of 10 hours at 45° C. The resultant mixture was stirred at 45° C. until the NCO value (NCO %) was stable, to obtain a reaction mixture comprising a monoisocyanate adducts.

2.6 g Lithium nitrate, 6.2 g of m-xylenediamine (46 mmol) and 65 g dimethyl sulfoxide were mixed at room temperature and the mixture was fed to the reaction mixture comprising the monoisocyanate adduct at 60° C. over a time period of 5 hours. The resulting mixture was heated to 80° C. and stirred at the same temperature until the NCO containt was 0.

Ethyl acetate was distilled out under reduced pressure to obtain urea urethane compound C2. C2 was a yellowish transparent liquid and was free flowing at room temperature. liquid that was free flowing at room temperature.

The molecular weight of C2 was 24008/mol as determined by GPC (according to DIN 55672-2, N,N-Dimethylacetamide, 1 mL/min, PMMA standard); and its PDI was 1.1.

The product remained stable (no precipitation or gel formation) upon storage (>2 months) under ambient conditions.

### Comparative Example 3: Urea Urethane Compound (C3) Prepared by Mixing C1 and C2

Comparative urea urethane compound C3 was prepared by mixing C1 (20 wt %) and C2 (80 wt %).

### III. Storage Stability of the Urea Urethane Compounds

The storage stability of the urea urethane compounds according to the present invention (U1-U9) was studied over a period of 2 months. Similarly, the storage stability of comparative examples C1-C3 was studied. The urea urethane compounds were ranked on a scale of 1 to 4, 1 being the best and 4 being the worst, based upon the particulars provided in table 1.

The urea urethane compounds with a ranking 1 to 3 are considered acceptable for use as an additive in coating formulations.

TABLE 1

| Ranking | Particulars |
|---|---|
| 1 | The product is a yellowish transparent liquid, is free flowing at |
| | room temperature and remains stable (no precipitation or gel |
| | formation) upon storage (>2 months) under ambient conditions |
| 2 | The product is a yellowish turbid liquid and is free flowing at |
| | room temperature, but it is not stable upon storage (>1 month) |
| | under ambient conditions, i.e. gel/precipitation formation occurs |
| 3 | The preparation runs homogenously, but the product is a turbid |
| | gel |
| 4 | The preparation cannot be processed homogenously because of |
| | the gel formation during the diamine dosing |

The results of the storage stability studies are provided in table 2 below.

TABLE 2

| Examples | Ranking |
|---|---|
| U1, U2, U3, U4, U5, U6, U7 and U8 | 1 |
| U9 | 2 |
| Comparative examples C1, C2, and C3 | 1 |

### III. Performance Test

### Thixotropy Measurement

The thixotropy for the urea urethane compounds U1-U9 was determined via shear jump measurement. A formulation for the viscosity measurement was prepared by adding 0.5 wt % of the compound into water. The mixture was shaken by hand for 30 seconds and then al lowed to stand.

The viscosity measurement started with a shear rate of 0.05 s⁻¹ for 200 seconds, followed by an immediate application of a high shear rate of 250 s⁻ for 60 seconds, which was followed by an immediate reduction of the shear rate to 0.05 s⁻ for 200 seconds.

A control sample was prepared without urea urethane compound.

The comparative sample were prepared in the same way as the samples for U1-U9, except that the urea urethane compounds of the present application was replaced by the urea urethane compounds C1-C3.

The viscosity measurement values in the table 3 are as follows:
Viscosity at t=199, immediately before the high shear was applied
Viscosity t=201, immediately after high shear was applied
Viscosity at t=259, immediately after high shear was removed
Viscosity t=450, well after high shear was removed

The viscosity measurements at different time intervals are provided in table 3.

TABLE 3
Viscosity measurement

Viscosity (pa · s)

| Examples | t = 199 | t = 201 | t = 259 | t = 450 |
|---|---|---|---|---|
| Control: No additive | 0.005 | 0.005 | 0.005 | 0.005 |

| | |
|---|---|
| C1 | Not soluble in water |

| | | | | |
|---|---|---|---|---|
| C2 | 3.5 | 0.006 | 0.5 | 1 |

| | |
|---|---|
| C3 | Not soluble in water |

| | | | | |
|---|---|---|---|---|
| U1 | 30 | 0.008 | 20 | 15 |
| U2 | 35 | 0.008 | 22 | 16 |
| U3 | 32 | 0.007 | 18 | 16 |
| U4 | 40 | 0.008 | 17 | 17 |
| U5 | 33 | 0.009 | 19 | 18 |
| U6 | 35 | 0.006 | 20 | 17 |
| U7 | 30 | 0.005 | 18 | 16 |
| U8 | 32 | 0.004 | 17 | 15 |
| U9 | 35 | 0.008 | 14 | 12 |

As is evident from the results provided in table 3, the viscosity of the formulation comprising urea urethane compounds U1 to U9 decreased significantly immediately upon application of high shear (i.e. 250 s⁻ for 60 seconds). Further, the viscosity increased immediately upon the removal of high shear. Thus, the formulation comprising urea urethane compounds U1 to U9 exhibited a significant recovery of the viscosity.

Thus, the addition of urea urethane compounds of the present invention to a formulation imparted thixotropic effect to the formulation, which was demonstrated by a drop in the viscosity of the formulation immediately after applying a shear stress, followed by gradual recovery of the viscosity as a function of time upon removal of shear stress.

In contrast, the comparative urea urethane compounds displayed lack of solubility in water or poor thixotropic effect.

1.-15. (canceled)

16. A urea urethane compound obtained by
(i) reacting
a. toluene diisocyanate with
b. a mixture of monohydroxy alcohols comprising
(b1) at least one monohydroxy alcohol of formula (I),
R¹—OH (I),
wherein
R¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
a radical of formula R¹¹(O—CₙH₂ₙ)ₓ—,
a radical of formula R¹¹[O—C(═O)—CᵥH₂ᵥ]ₓ—, and
a radical of formula R¹¹(O—CₙH₂ₙ)ₓ₋₁ [O—C(═O)—CᵥH₂ᵥ]ₓ—,
wherein
R¹¹ is selected from linear or branched, substituted or unsubstituted C₄-C₂₂ alkyl, linear or branched, substituted or unsubstituted C₄-C₂₂ alkenyl, substituted or unsubstituted C₆-C₁₂ cycloalkyl, linear or branched, substituted or unsubstituted C₇-C₂₄ aralkyl, and substituted or unsubstituted C₆-C₂₄ aryl,
n is an integer from 2 to 4,
x is an integer from 1 to 15, and
v is an integer from 4 to 6; and
(b2) at least one monohydroxy alcohol of formula (II)
R²—OH (II),
wherein R² is a radical of formula CₚH₂ₚ₊₁ (O—C_{q}H_{2q})ᵣ—,
p is an integer from 1 to 3,
q is an integer from 2 to 4 and
r is an integer from 1 to 50,
wherein the molar ratio of the at least one monohydroxy alcohol of formula (I) to the at least one monohydroxy alcohol of formula (II) is in the range of 10:1 to 1:10, and
the molar ratio of the total amount of the mixture of monohydroxy alcohols to the toluene diisocyanate is in the range of >1.0:1.0 to ≤1.5:1.0;
to obtain a mixture comprising at least two monoisocyanate adducts;
(ii) reacting the mixture comprising at least two monoisocyanate adducts obtained in step (i) with at least one diamine to obtain the urea urethane compound.

17. The urea urethane compound according to claim 16, wherein the toluene diisocyanate is selected from 2, 4-toluene diisocyanate and a mixture of 2, 4-toluene diisocyanate and 2, 6-toluene diisocyanate.

18. The urea urethane compound according to claim 16, wherein the at least one monohydroxy alcohol of formula (I) is selected from the group consisting of butyltriglycol, butyldiglycol, butyltetraglycol, butanol, isotridecyl alcohol, oleyl alcohol, Guerbet alcohols containing 8 to 20 carbon atoms, linoleyl alcohol, lauryl alcohol, stearyl alcohol, cyclohexanol, benzyl alcohol, 4-dodecylphenol, ethoxylated triphenylmethanol and ethoxylated 4-dodecylphenol.

19. The urea urethane compound according to claim 16, wherein the at least one monohydroxy alcohol of formula (II) is methoxy polyethylene glycol.

20. The urea urethane compound according to claim 16, wherein the molar ratio of the total amount of the mixture of monohydroxy alcohols to the toluene diisocyanate is in the range of >1.0:1.0 to <1.5:1.0.

21. The urea urethane compound according to claim 16, wherein the at least one diamine is selected from diamines of formula (IIIa), (IIIb), (IIIc), (IIId) and (IIIe);
H₂N—R³—NH₂ (IIIa),
wherein R³ is —C_{y}H_{2y}— and y is an integer from 2 to 12, 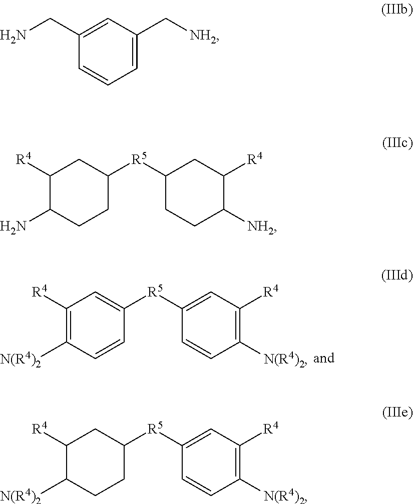
wherein, in formula (IIIc), formula (IIId) and formula (IIIe), R⁴ are identical or different and are selected from H, CH₃—, C₂H₅— and C₃H₇—, and R⁵ is selected from —CH₂—, —C₂H₄—, —C₃H₆— and —C₆H₁₂—.

22. The urea urethane compound according to claim 16 having a weight average molecular weight in the range of ≥300 g/mol to ≤5000 g/mol, determined according to DIN 55672-2.

23. A process for preparing a urea urethane compound according to claim 16 comprising:
i. introducing toluene diisocyanate into a reactor;
ii. mixing at least one monohydroxy alcohol of formula (I) and at least one monohydroxy alcohol of formula (II) to obtain a mixture comprising monohydroxy alcohols;
iii. adding the mixture obtained in step (ii) into the reactor and reacting the monohydroxy alcohols with toluene diisocyanate to obtain a mixture comprising at least two monoisocyanate adducts;
iv. preparing a mixture by mixing at least one diamine, at least one polar aprotic solvent and at least one metal salt catalyst; and
v. adding the mixture obtained in step (iv) into the reactor to react with the mixture comprising at least two monoisocyanate adducts obtained in step (iii) to obtain the urea urethane compound.

24. The process according to claim 23, wherein the mixture comprising monohydroxy alcohols obtained in step (ii) further comprises at least one catalyst selected from the group consisting of p-toluenesulfonic acid, H₂SO₄, HCl and acetic acid.

25. The process according to claim 23, wherein the at least one polar aprotic solvent is selected from the group consisting of dimethyl sulfoxide, N,N-dimethylformamide, N,N-dimethylacetamide, N-methylpyrrolidone, N-ethylpyrrolidone, N-propylpyrrolidone, N-butylpyrrolidone, N,N,N′,N′-tetramethylurea, hexamethyl-phosphoric acid triamide and methyl 5-(dimethylamino)-2-methyl-5-oxopentanoate.

26. The process according to claim 23, wherein the metal salt catalyst is selected from the group consisting of lithium chloride, lithium nitrate, lithium bromide, and dioctyl sulfosuccinate sodium salt.

27. The process according to claim 23, wherein the molar ratio of the metal salt catalyst to the at least one diamine is in the range of 0.3:1.0 to 1.0:1.5.

28. A liquid composition comprising the urea urethane compound according to claim 16 in an amount in the range of ≥0.01 wt.-% to ≤10.0 wt.-% based on the total weight of the liquid composition.

29. The liquid composition according to claim 28, wherein the composition is a paint, water based coating formulation, solvent based coating formulation, lacquer, varnish, paper coating, wood coating, adhesive, ink, cosmetic formulation, detergent formulation, textile, drilling muds plaster formulation, cement composition, formulation for plasterboard, for hydraulic binders such as mortar formulations, formulation for ceramics and for leather.

30. A method comprising providing the urea urethane compound according to claim 16 and incorporating the compound in liquid compositions as a thixotropic agent for paint and coating formulations, adhesive, paint lacquer, PVC plastisol, ink and cement formulations.
